(19) United States
(12) Patent Application Publication
(10) Pub. No.: US 2014/0350868 A1
(43) Pub. Date: Nov. 27, 2014

(54) METHOD FOR SENSOR CALIBRATION

(71) Applicant: EPISENTEC AB, Sollentuna (SE)

(72) Inventor: Anders Hanning, Sollentuna (SE)

(73) Assignee: EPISENTEC AB, Sollentuna (SE)

(21) Appl. No.: 14/359,606

(22) PCT Filed: Nov. 13, 2012
(86) PCT No.: PCT/EP2012/072512

§ 371 Date: May 21, 2014

(30) Foreign Application Priority Data
Nov. 22, 2011 (SE) 1151110-2

(51) Int. Cl. G01N 21/59

(52) U.S. Cl. CPC G01N 21/59; G01N 2021/5903
USPC 702/30; 356/432

(57) ABSTRACT

The present invention provides a method of determining the amount of an optical probe species binding to or releasing from an optical sensor surface characterized in that the determination comprises the steps of: a) determining, at one single wavelength or at more than one wavelength, a physical measurand (xᵢ) that is related to the absorptivity of said probe, b) correlating the value of the measurand to the amount of said optical probe species binding to or releasing from said surface, respectively, wherein the physical measurand (xᵢ) of step a) is a physical measurand in which the contribution from the refractive index is substantially zero. The present invention further provides different uses of a peak width as well as a computer program product and reagent kits for the disclosed methods.

### TECHNICAL FIELD OF THE INVENTION

The present invention relates to an improvement in the kind of methods used for probing the amount or concentration of a chemical species binding to or releasing from an optical sensor or biosensor surface.

### BACKGROUND ART

The use of chemical sensors and biosensors is well established. Such sensors usually consist of two distinguishable elements. One element provides the chemical or biochemical selectivity of the sensor; this element usually consists of a selective layer attached to a solid surface. The selectivity may be provided by e.g. a selectively absorbing matrix, a chelating agent, an antibody, a selectively binding protein, a nucleic acid strand, or a receptor. The determination of an analyte of interest in a sample usually involves the binding or release of the analyte, or the analyte influencing the binding or release of some other species, to or from the selective layer, respectively. The second element provides the monitoring of the binding or release of species to and from the sensor surface, respectively.

One important class of sensors is based on optical monitoring of the binding event; such sensors are called optical sensors. The optical readout mechanism may be based on changes in e.g. absorbance, fluorescence, or refractive index. Many such sensors are based on the phenomenon of internal reflection; for example, such sensors may be based on surface plasmon resonance (SPR), frustrated total internal reflection, optical waveguiding, critical angle refractometry, interference refractometry, dual polarization interferometry, and other methods. The following discussion is mainly focused on SPR sensors, but, as is obvious to the skilled person, many aspects of the discussion are also applicable to other kinds of optical sensors in general and internal reflection based sensors in particular.

Further, there are two main classes of SPR sensors. One is based on readout of the specific angle corresponding to the resonance at a defined wavelength; the other is based on readout of the specific wavelength corresponding to the resonance at a defined angle. There also exist hybrid variants where both the angle and the wavelength are varied. The following discussion is focused on SPR sensors with angular readout. Moreover, for simplicity, the discussion is focused on the so called Kretschmann SPR configuration, but the discussion may be applicable also to other configurations, like e.g. the Otto configuration and different configurations involving gratings and waveguides.

The use of SPR sensors is well-established (see e.g. L. M Lechuga, “Optical Biosensors”, Chap. 5 in “Biosensors and Modern Biospecific Analytical Techniques”, L. Gorton (ed.) Elsevier, Amsterdam, 2005; J. Homola, Chem. Rev. 2008, 108, 462). In general, different species can be analysed in real time and without the use of any labels attached to the analytes. The sensitivity is adequate for many purposes, and so is the robustness. However, it is also well known that the use of SPR sensors in certain applications is problematic and that the performance of SPR sensors may be inadequate for some purposes. The sensitivity of SPR sensors, for example, is limited, and may be inadequate for the analysis of small molecules. Another problem may be the universal nature of the readout when labelling is not used; SPR has no inherent mechanism for distinguishing between the binding of the analyte and the binding of any other species. Especially problematic is the so called “non-specific binding” of proteins and other more or less well-defined species in connection with samples of biochemical origin. A third problem is the influence of a number of noise sources like e.g. temperature variations, mechanical vibrations, and spurious variations of the composition of the medium in contact with the sensor surface. As a consequence of these problems, quantitative analysis and sensor calibration may show insufficient accuracy and precision for SPR sensors.

SPR sensors are commonly used to measure the refractive index, i.e. the real part of the complex refractive index, of sample media. However, it is well-known that SPR sensors may also be used to indirectly measure the absorbance (a more correct term is extinction coefficient, but the term absorbance is used here since it is more easily understood), i.e. the imaginary part of the complex refractive index, since light absorption influences the shape of the SPR curve. Also the thickness of adsorbates on the sensor surface can be deducted from SPR measurements. The measurement of these three parameters is discussed by e.g. H. Kano and S. Kawata, Appl. Opt. 1994, 33, 5166; S. R. Karlsen et al., Sens. Actuators B 1995, 24-25, 747; Z. Salamon et al., Biochim. Biophys. Acta 1997, 1331, 117; A. A. Kolomenskii et al., Appl. Opt. 2000, 39, 3314; S. Wang et al., Rev. Sci. Instr. 2001, 72, 3055; and S. Ekgasit et al., Sens. Actuators B 2005, 105, 532.

SPR sensors have also been applied to monitor chromogenic reactions, i.e. chemical reactions accompanied by a colour change. Some examples are silver ion detection reported by Y. Hur et al., Anal. Chim. Acta 2002, 460, 133, and hydrogen ion detection reported by P. Uznanski and J. Pecherz, J. Appl. Pol. Sci. 2002, 86, 1459. However, chromogenic reactions represent a special case, since simple binding of chemical species to a solid surface is generally not accompanied per se by a colour change.

A number of attempts have been made to improve the performance of SPR sensors. In U.S. Pat. No. 5,573,956 is described how the use of refractive index-enhancing species may improve the sensitivity of SPR assays. Similar approaches have later been proposed by H. Komatsu et al., Sci. Tech. Adv. Mater. 2006, 7, 150, and by M. Nakkach et al., Appl. Opt. 2008, 47, 6177. In U.S. Pat. No. 5,641,640 is described how the measurement of the refractive index at more than one wavelength may increase the sensitivity and reduce some sources of noise. A similar approach was later discussed by O. Esteban et al., Opt. Lett. 2006, 31, 3089. In JP11118802 is discussed how a specimen of low concentration and low molecular weight may be determined by using light of a wavelength equal to the absorption wavelength of the specimen or a pigment bound thereto. In WO02073171 is briefly noted that the absorbance of a sample may be measured via changes in the shape (reflectance minimum and dip width) of the SPR curve. In JP2002090291 is discussed how an SPR sensor may detect low-molecular matter such as ions by utilizing a sensing layer containing matter which changes its optical absorption characteristics by capturing low molecular matter; i.e. by utilizing a chromogenic indicator. In JP2002357536 is noted that a light absorbing substance may be used to increase the sensitivity of SPR assays in a manner similar to the above mentioned U.S. Pat. No. 5,573,956 and U.S. Pat. No. 5,641,640. It is also, in a manner similar to the above mentioned WO02073171, noted that an absorbing substance may change the shape of the SPR curve. In JP2003215029 is discussed an apparatus for the measurement of both surface plasmon resonance and optical absorption spectra; it is to be noted that the apparatus utilizes wavelength readout, not angular readout, so discussing the shape of the angular readout SPR curve is not relevant in this case.

### SUMMARY OF THE INVENTION

As discussed above, several attempts have been made to improve the performance of SPR sensors by utilizing their capacity as absorbance sensors. However, one problem is that most physical measurands that depend on the absorbance, like e.g. the SPR peak width defined in some loose sense, also depend to a smaller or larger degree on the refractive index. Thus, the above described attempts to measure the absorbance generally yield a mixed absorbance and refractive index signal. It has not previously been realized that by determining a plurality of physical measurands related to the absorbance, and selecting the one to which the contribution from the refractive index is the smallest, methods for a purer and more accurate estimate of the absorbance may be obtained. Neither has it been realized that such a selection procedure can improve methods for determining the amount of an optical probe species binding to or releasing from an optical probe surface. The present invention provides such improved methods and procedures.

As first aspect of the invention, there is provided a method of determining the amount of an optical probe species binding to or releasing from an optical sensor surface characterized in that the determination comprises the steps of:

a) determining at one single wavelength or at more than one wavelength, a physical measurand (xᵢ) that is related to the absorptivity of the probe,

b) correlating the value of the measurand to the amount of the optical probe species binding to or releasing from the surface, respectively,

wherein the physical measurand (xᵢ) of step a) is a physical measurand in which the contribution from the refractive index is substantially zero.

The present invention is based on the insight in how to use information from a physical measurand in which the contribution from the refractive index is substantially zero for calibration and reducing noise in an optical sensor and for quantifying the amount of an optical probe that binds to the sensor. Several aspects and configurations of the general inventive concept is disclosed herein. The expression “optical probe” is used to denote a species that is binding to or releasing from an optical sensor surface, and which may be detected by the sensor, and which has a detectable absorbance at least one measurement wavelength. In case the analyte itself fulfils these conditions, it may be used as an optical probe per se. The optical probe may also have fluorescent properties. However, in most cases the optical probe is used to determine the amount or concentration of analyte in a more indirect way; the analyte may e.g. affect the binding or release of the optical probe to or from, respectively, the optical surface. Conceivable ways to achieve this include, but are not limited to, a sandwich assay, a competition assay, an inhibition assay, or a displacement assay. In some conceivable embodiments, the optical probe may be used to chemically label some other species; e.g. the analyte itself may be labelled, a competing or analogous species to the analyte may be labelled, or some secondary or tertiary reagent, e.g. a secondary antibody, may be labelled.

The optical properties of the optical probe are described by its complex refractive index. The shorter term “refractive index” is used to denote the stricter term “real part of the complex refractive index”. The terms “extinction coefficient” and “absorbance” are used to denote “imaginary part of the complex refractive index”. The complex refractive index is strictly a property of an optical continuum; when discussing properties of discrete chemical species, like e.g. molecules, terms like “molar refractive index increment” and “absorptivity” may be used since they may be more easily understood. The distinction and relationship between optical continuum properties and the optical properties of discrete species are well known to the skilled person.

The term “one wavelength” is used to denote a sharp wavelength peak or a narrow wavelength interval, such as that that may be obtained from a light emitting diode or a laser, or a broadband light source or a light source emitting several wavelengths together with a bandpass filter or a monochromator.

A “physical measurand” relates to a physical property, e.g. a property of the studied system, that is influenced by the binding or releasing of an optical probe at a sensor surface, which also can be measured or estimated with the optical sensor.

A physical measurand that is related to the absorbtivity may be a physical measurand that is primarily related to the absorbtivity.

The optical properties of any homogenous material is defined by the extinction coefficient, c, and the refractive index, n. This is also true for the sample in the case of e.g. surface plasmon resonance (SPR). The well-known basic equation of SPR, relating the resonance angle Θ to the refractive index n of a non-absorbing sample is

nₚ sin Θ=[∈ₘn²/(∈ₘ+n²)]^{1/2} /A/

in which nₚ is the refractive index of the glass and ∈ₘ is the dielectric constant of the metal [see e.g. H. Raether, Surface Plasmons on Smooth and Rough Surfaces and on Gratings, Springer, Berlin 1988]:

The relation between the peak width ΔΘ and the extinction coefficient E of the sample is also well established:

ΔΘ_{1/2}=4γ/(nₚ cos Θ) /B/

in which ΔΘ_{1/2} is the peak half width and γ is a factor that depends inter alia on ∈ and ∈ₘ.

[see e.g. J. Homola, Electromagnetic Theory of Surface Plasmons in J. Homola (ed.), Surface Plasmon Resonance Based Sensors, Springer, Berlin, 2006]

However, in analogy with many equations of theoretical physics, equations A and B may not hold perfectly true in practice. Thus, for absorbing samples, there is a slight dependence of Θ on the absorbtivity, albeit much smaller than the dependence on n. Analogously, there is also a slight dependence of ΔΘ on n, albeit much smaller than the dependence on α. Nevertheless, a skilled person in the field of optical biosensors fully understands, with knowledge of e.g. equations A and B above, that Θ is an example of a measurand that is primarily related to the refractive index and that ΔΘ is an example of a measurand that is primarily related to the absorptivity. Consequently, with knowledge of the theoretical physics behind the phenomenon occurring when an optical probe is binding to or releasing from an optical sensor surface, the skilled person is able to unambiguously classify a measurand as “related to the absorptivity” or “primarily related to the absorptivity”. For example, since the peak width ΔΘ may be defined in different ways, e.g. as the standard deviation of the SPR curve or as the width of the curve at some predefined intensity value, the skilled person understands that these measurands are “measurands that are primarily related to the absorptivity”.

Further, the skilled person, with knowledge e.g. of Equations A and B, further understands what a measurand “for which the contribution from the refractive index is substantially zero” refers to. As discussed above, most measurands may be to some extent dependent on the refractive index, but a measurand “for which the contribution from the refractive index is substantially zero” has a dependence on the refractive index that is smaller than the dependence on e.g. the absorptivity.

The skilled person may for example vary the refractive index of the sample and measure how different physical measurands vary in response in order to find a measurand for which the contribution from the refractive index is substantially zero.

Consequently, the first aspect of the invention is based on the insight that measuring at least one measurand that is related to absorptivity but in which the contribution from the refractive index is substantially zero and using this measurand (or the information obtained from the measurand) when determining the amount of an optical probe species binding to or releasing from an optical sensor surface lads to results that are less influenced by noise.

In embodiments of the first aspect, the physical measurand of step a) is selected performing the steps:

a1) determining a plurality of physical measurands xₙ that are related to the absorbtivity of the probe, and

a2) selecting a measurand xᵢ of the plurality of measurands in which the contribution from the refractive index is substantially zero.

Step a2) may for example include selecting the measurand of the plurality of measurands that has the smallest dependence on the refractive index.

In embodiments of the first aspect, the optical sensor is based on surface plasmon resonance (SPR).

The SPR sensor may be an SPR sensor with angular readout.

As an example, the plurality of measurands may be related to the peak width (PW) in the SPR curve of the reflected light intensity as a function of incidence angle.

The inventor has found that a definition of a peak width is advantageous since it may provide for a measurand in which the contribution from the refractive index is substantially zero. This is further shown in the examples of the present disclosure.

The peak width may thus be the peak width of the “SPR-dip” in the sensorgram of a SPR. For example, the peak width (PW) may be defined as the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

As an example, step a1) may comprise:

determining, for the physical measurands that are related to the peak width, the change in peak width (ΔPW) upon a change in optical properties of the sample,

and step a2) may comprise

selecting at least one measurand of the plurality of measurands in which k₂ is minimized or the ratio k₁/k₂ is maximized in the equation

ΔPW=k₁*Δ∈+k₂*Δn,

in which Δ∈ is the change in absorptivity and Δn is the change in refractive index upon a change in optical properties of the sample.

Further, in embodiments of the first aspect, step b) comprises using the values of the measurand to discriminate between measurement noise (N) and the signal from the binding or release of the optical probe species.

The expression “noise” or “measurement noise” is to be interpreted in a wide sense. It is used to denote any contribution to any measurand that obscures, disturbs, or interferes with the determination of the optical probe species, i.e. not only short-term random variations of the measurands. In particular, the term is used to denote unwanted or uncontrolled temperature variations, spurious variations of the composition of the medium in contact with the sensor surface, and unwanted or uncontrolled binding or release of any other chemical species to or from, respectively, the sensor surface. So called “non-specific binding” is included in the definition of “noise”. It is to be understood that several, defined or undefined, sources of noise may contribute simultaneously. The different sources of noise may contribute in a similar or dissimilar way to the set of measurands. In most cases, the contribution from different sources of noise can be summed up in an additive way.

Consequently, the method of the first aspect provides for more accurate results when determining interactions between the optical probe and the sensor surface.

As a compliment or as an alternative, step b) may comprise the steps:

b1) using the physical measurand x₁ for reducing noise in the optical sensor, and

b2) determining the amount of the optical probe species binding to or releasing from the surface.

Consequently, the determination of step b2) is less influenced by noise compared to if step a) was not carried out. Further, when discussing step b) in the present disclosure, the embodiments may refer to step b1) above.

In embodiments of the first aspect, step b) comprises determining at least one function f of the measurand f(x₁) such that the signal-to-noise ratio (S/N) of the optical probe binding to or releasing from the optical sensor surface increases.

Thus, the S/N ratio may increase compared to if the method according to the present disclosure is not performed, i.e. if steps a) and b) as defined herein are note performed.

The skilled person understands how to determine a function such that the signal-to-noise ratio increases. This may be performed e.g. by iterative processes.

As an example, the measurement noise (N) may be due to at least one additional chemical species binding to or releasing from the surface, and that step b) comprises using the values of the measurand to discriminate between binding or releasing of the optical probe species and the at least one additional chemical species.

This embodiment includes the case of “non-specific binding”. In this aspect, as in other aspects, it is not excluded that several sources of noise may contribute simultaneously in a similar or dissimilar way. As an example, non-specific binding of uncoloured proteins (like e.g. albumin) to the surface contributes primarily to refractive index-related measurands and less to absorbance-related measurands, while optical probe binding will contribute heavily to absorbance-related measurands.

As a further example, the measurement noise (N) has been determined by means of varying the binding or release of an additional chemical species to or from, respectively, the optical sensor surface.

The binding or release may have been varied in a controlled way.

Further, the measurement noise (N) may be due to temperature variations, and that step b) comprises using the values of the measurand to discriminate between binding or releasing of the optical probe species and temperature variation noise.

Temperature variations mainly contribute to refractive index-related measurands. The refractive index of water, e.g., decreases with 0.0001 refractive index units for each 1° C. temperature increase. The contribution of temperature variations to absorbance related-measurands, on the other hand, is significantly smaller, unless the medium in contact with the optical probe surface is strongly absorbing.

As an example, the measurement noise (N) may have been determined by means of varying the temperature of the medium in contact with the optical sensor surface.

The temperature may have been varied in a controlled way.

Further, the measurement noise may be due to variations of the composition of the medium in contact with the sensor surface, and that step b) comprises using the values of the measurands to discriminate between binding or releasing of the optical probe species and the variations of the composition.

Again, as long as the composition variations are due to uncoloured species, the influence will be mainly on refractive index-related measurands, while coloured species will influence also absorbance-related measurands heavily. As an example, the measurement noise (N) has been determined by means of varying the composition of the medium in contact with the optical sensor surface.

The composition may have been varied in a controlled way and the medium may for example be a buffer.

In embodiments of the first aspect, the sensing principle of the optical sensor is based on internal reflection.

Internal reflection is often used in connection with chemical sensors and biosensors. The internally reflected light creates an evanescent wave that is used for probing the sensor surface and its immediate environment. One advantage of internal reflection methods is that the probing light beams need not pass through the sample solution, which could otherwise cause problems related to the absorption and scattering of light.

As examples, the sensing principle of the optical sensor may be based on optical waveguiding refractometry, frustrated total internal reflection, waveguide-based surface plasmon resonance, grating coupler refractometry, interference refractometry, or dual polarization interferometry.

Common to these methods are that they are used to probe the refractive index close to the sensor surface, but that also absorbance of light on or in the immediate vicinity of the surface will influence the measurement.

As also discussed above, the sensing principle of the optical sensor may be based on surface plasmon resonance (SPR) with angular readout.

This is probably the most used method for biosensing. Also this method is primarily intended for refractometry, but the measurement is also influenced by absorbance of light on or in the immediate vicinity of the surface. This influence is usually considered to be a disadvantage of the method, but, as is detailed in the description of the present invention, it can also be turned into a distinct advantage.

Further, the at least one measurand (x₁) that is related to the absorptivity of the probe may be selected among the minimum reflectance value, the width, the standard deviation, the skewness, and the kurtosis of the SPR curve.

In embodiments of the first aspect, at least one measurement wavelength is selected close to the wavelength of maximum absorptivity of the probe, preferably within 50 nm from the maximum, and more preferably within 20 nm from the maximum.

The inventor ahs advantageously found that the influence on the refractive index is small close to the absorption maximum of absorbing substances. The inventor has thus found that, to a first simplified approximation, the optical probe may be regarded as contributing only to the absorbance-related measurands if the at least one measurement wavelength is selected close to the wavelength of maximum absorptivity of the probe.

In another configuration of the first aspect of the invention, there is provided a method for estimating the absorbance ∈ of a sample in an optical sensor based on surface plasmon resonance (SPR), comprising the steps of

a) determining a plurality of physical measurands (xₙ) that are related to the absorbance ∈ of the sample;

b) selecting a physical measurand xᵢ from the plurality of physical measurands (xₙ) step a) in which the contribution from the refractive index is substantially zero, and

c) using the physical measurand xᵢ from step b) for estimating the absorbance ∈.

Thus, the inventive concept provides for a straight-forward way of analysing or determining the absorbance of a sample in a SPR-sensor.

As an example, the plurality of measurands xₙ are different measurands related to the peak width (PWᵢ) in the SPR curve of the reflected light intensity as a function of incidence angle.

As an example, the peak width (PW) may be defined as the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

Further, as an example,

step b) may comprise determining the change in the peak widths (ΔPWₙ) for the plurality of measurands xₙ upon a change in optical properties of a sample medium run in the SPR sensor, and

step c) may comprise selecting a ΔPWᵢ from the ΔPWₙ in which k₂ is minimized or the ratio k₁/k₂ is maximized in the equation ΔPW=k₁*Δ∈+k₂*Δn, in which Δ∈ is the change in absorptivity and Δn is the change in refractive index upon a change in optical properties of the sample, and using ΔPWᵢ for estimating the absorbance ∈

In another configuration of the first aspect of the invention, there is provided a calibration method for an optical sensor based on surface plasmon resonance (SPR), comprising the steps of

a) running at least two calibration samples having different refractive index n and at least two calibration samples having different absorbance ∈,

b) determining at least one peak width PWₙ in the SPR curve of the reflected light intensity as a function of incidence angle for each sample,

c) estimating the change (ΔPWₙ) for the at least one peak widths PWₙ between the calibration samples,

d) selecting a ΔPWᵢ of the ΔPWₙ of step c) in which k₂ is minimized or the ratio k₁/k₂ is maximized in the relation ΔPW=k₁*Δ∈+k₂*Δn, in which Δ∈ is the change in absorptivity and Δn is the change in refractive index upon a change in optical properties of the sample

Thus, the inventive concept also provides a method for calibrating a SPR-sensor.

The term “calibration” is used here to denote any procedure for improving the quantitative accuracy or precision of an analytical method. Calibration is usually performed as a separate experimental step before (or after) the analytical step per se. During the calibration step, the specific contribution of the binding or release of the optical probe and/or the contribution of at least one source of noise to the set of measurands is determined in a quantitative or semi-quantitative way. During the analytical step, the so determined specific contributions are utilized to improve the accuracy or the precision through a mathematical procedure.”

The SPR-sensor may be an SPR-sensor with angular readout.

“Running a sample” refers to using the sample in the SPR, i.e. injecting it according to the instrumental protocol.

As an example, the method may further comprise the step

d) using the PWᵢ for analysing the amount of an optical probe species in the samples binding to or releasing from the optical sensor surface

Further, the at least one peak width of step b) may be defined as the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

In a second aspect of the invention, there is provided the use of a peak width PWᵢ for estimating the absorbance of a sample in a surface plasmon resonance (SPR) sensor, wherein the PWᵢ has been selected as a peak width from a plurality of definitions of the peak width in the SPR curve of the reflected light intensity as a function of incidence angle, and PWi is a definition of the peak width in which the contribution from the refractive index is substantially zero.

As a configuration of the second aspect, there is provided the use of a peak width PWᵢ in the calibration of a surface plasmon resonance (SPR) sensor, wherein the PWᵢ has been selected as a peak width from a plurality of definitions of the peak width in the SPR curve of the reflected light intensity as a function of incidence angle, and PWi is a definition of the peak width in which the contribution from the refractive index is substantially zero.

As understood from the present disclosure, the term “use of a peak width” may refer to the use of the measured peak width, or information obtained from the measured peak width.

In embodiments of the second aspect, the plurality of definitions of the peak width (PW) is defined comprises the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

As a third aspect of the invention, there is provided the use of an optical probe in the method according to the first aspect above.

Such use is thus advantageous in that it e.g. provides for performing the method according to the first, second and/or third aspect above.

As a fourth aspect, there is provided a computer program product comprising computer-executable components for causing a device to perform any one or all of the steps recited in relation to the first or second aspects when the computer-executable components are run on a processing unit included in the device.

As an example, the computer program product may include a software for performing at least step c) in any method according to the aspects of the invention. Thus, the computer program product may comprise a software e.g. for determining or estimating a function f such that the signal-to-noise ratio (S/N) of the optical probe binding to or releasing from the optical sensor surface increases.

Further, the computer program product may also include a software for effecting controlled variations of the different sources of noise in embodiments of the inventions. The software may bring about controlled temperature changes or controlled changes of the composition of the medium in contact with the optical sensor surface, or effect injections of optical probe or additional binding species or other liquid compositions.

In order to provide for an accurate implementation of the methods and uses of the present disclosure and for determination of the optical probe binding to or releasing from the sensor surface, the inventor has realized the value of combining at least one optical probe species with e.g. instructions on how to use the optical probe according to the methods and uses of the present disclosure, in a single kit.

As a fifth aspect of the invention, there is provided a reagent kit comprising at least one optical probe species and instructions on how to use it in a method according to the invention.

The kit may also contain one or several reagents, buffers, or other chemicals, of which at least one is an optical probe species. The optical probe species may be e.g. a natural or synthetic dye molecule, a reactive dye molecule, a dye molecule coupled to another species, a coloured particle or bead, or a coloured protein. The kit is thus suitable for use for the intended method. Various components of the kits may also be selected and specified as described above in connection with the method aspects of the present disclosure.

The instructions comprises a description of how to use the kit for the intended method.

In embodiments of the fifth aspect, the reagent kit comprises a first sample with a measurable RI and with a negligible absorbance, a second sample with a RI different from that of the first sample and with a negligible absorbance, and a third sample with a measurable absorbance.

In embodiments of the fifth aspect, the kit is further comprising the computer program product according to the fourth aspect above.

### BRIEF DESCRIPTION OF THE DRAWINGS

FIG. 1 shows a schematic drawing of the resulting graph of the reflected light intensity as a function of incidence angle, and also an example of the peak width of the “SPR-dip”.

FIG. 2 is an example of an SPR measurement at 670 nm. The graph shows the peak width of the SPR dip measured at a number of different intensity levels for a sucrose sample and a dye sample as compared to a buffer solution.

### DETAILED DESCRIPTION

### Examples

### General Example

The phenomenon of Surface Plasmon Resonance (SPR) is observed when light is reflected at the surface between a transparent optical material (usually glass) and a thin film of an SPR active metal (usually gold). At an incidence angle larger than the critical angle, the light is totally reflected. However, at a certain angle above the critical angle, light is absorbed and dissipated in the shape of a surface plasmon wave. As is well known, this SPR absorption angle depends on the refractive index of the material on the other side of the gold layer (the sample). However, it is found that the angle at which SPR is observed is not an infinitesimally narrow angle; rather light is absorbed in an angular interval a couple of degrees wide.

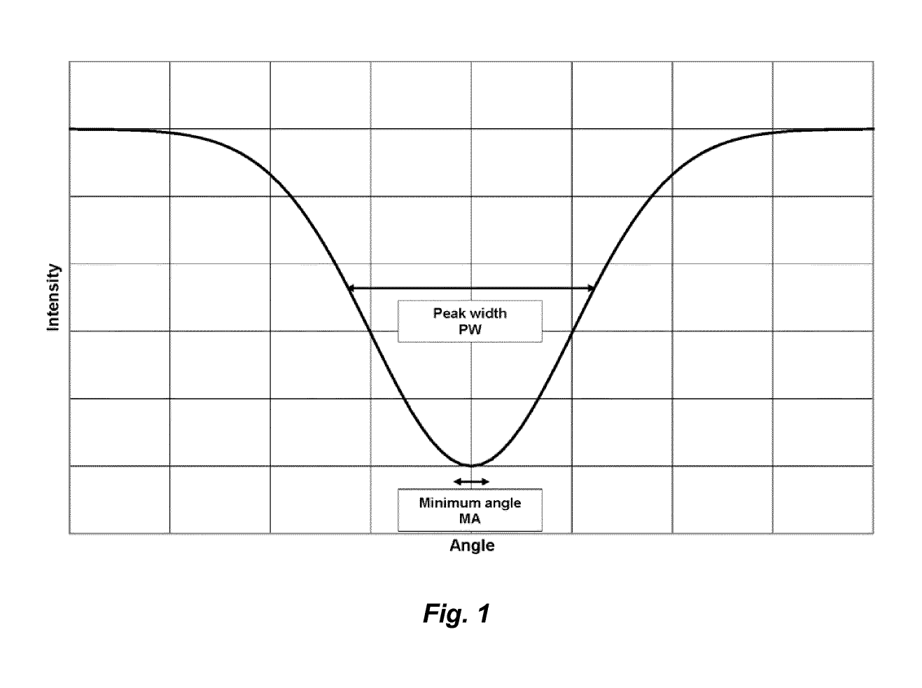

In practice, SPR is observed when the light intensity is measured as a function of the reflection angle. FIG. 1 shows the resulting graph of the absorption in the shape of an SPR curve or SPR dip

The optical properties of the sample is defined by the extinction coefficient, ∈, and the refractive index, n.

The minimum angle (MA) depends to a major extent on n, but to a minor extent also on a number of other variables.

The peak width (PW) depends on a number of variables, of which one major variable is ∈. However, PW depends also on a number of other variables, including e.g. the surface roughness and the gold film thickness, and to a minor extent also on n.

Supposing that only the optical properties of the sample medium changes, while all other variables are constant, a change in PW will depend only on changes in ∈ and n:

ΔPW=k1*Δ∈+k2*Δn (Equation 1)

For absorbing samples, the n term is in general much smaller than the ∈ term. In cases of absorbing samples, measurement of PW may yield an approximate but somewhat rough determination of sample absorbance. Now, there is no single, unique definition of PW. On the contrary, PW may be defined in an infinite number of different ways, e.g.:
The peak width at any predetermined value of the absolute intensity.
The peak width at any predetermined value of the relative intensity (expressed as a percentage between the maximum and the minimum intensity).
The peak width at any predetermined intensity value above the minimum intensity. (The minimum intensity may vary somewhat due to changes in the optical properties of the sample.)
The standard deviation of the SPR dip determined relative to a baseline defined at any absolute or relative intensity value.

The inventor has found that the constants k1 and k2 in Equation 1 will vary depending on how PW is defined, and that this variation may be utilized in order to increase the performance of the SPR-sensor. The inventor has found that there may even be definitions of PW for which k2 is zero or at least small enough to be neglected from a practical point of view. For such definitions of PW, Equation 1 is reduced to:

ΔPW≈k1*Δ∈ (Equation 2)

Hence, PW may be used to determine the absorbance without any correction for changes in n. The inventor has also found that PW and the choice of the “best” PW depends on many variables, e.g. the absorbance spectrum of the sample (i.e. the specific dye used as optical probe), the actual value of the minimum angle (MA), the refractive index and possible extinction coefficient of the glass, the specific instrument used (e.g. the actual wavelength of the instrument as opposed to the nominal wavelength), the roughness of the sensor surface, the gold film thickness etc. Consequently, it is preferred to do perform “best PW” calibration regularly, e.g. on a daily basis, for accurate measurements. Due to the complex pattern of PW dependencies, it may be difficult to predict the “best PW” on purely theoretical grounds. Rather, it should be determined through an empirical calibration procedure.

Also additional performance parameters may be weighed in when selecting the “best PW”, e.g.:
The magnitude of k2, i.e. the sensitivity of the method.
The linearity of k2 versus the absorbance or the concentration of optical probe.

The following non-limiting examples will further illustrate the present invention.

### Example 1

This example was performed on an SPR instrument with angular readout and full angular scans were continuously recorded at 670 nm. The SPR chip was a gold covered glass chip. Continuous flow of buffer was used for baseline readings. First, 1% of sucrose dissolved in running buffer was injected. Then, a 50 ppm solution of a dye with strong absorbance at 636 nm dissolved in running buffer was injected. The sucrose represents a sample that changes the refractive index but that possesses essentially no absorbance. The dye represents a sample that changes both the refractive index and the absorbance. The light intensity data was saved in a 16-bit format, i.e. represented by 65536 pixels. In a first data evaluation step, the SPR minimum angle was calculated. The minimum angle change was +0.76 angular units for the sucrose sample and +0.09 angular units for the dye sample. In a second step, a threshold was set at 65000 intensity pixels and the SPR dip width at 75% distance from the threshold to the dip minimum intensity was calculated. The width change was −0.11 angular units for the sucrose sample and +0.40 angular units for the dye sample. In a third step, the threshold was set at 55000 pixels, and the SPR dip width at 75% distance from the threshold to the dip minimum intensity was calculated. The width change was +0.15 angular units for the sucrose sample and +0.44 angular units for the dye sample. From interpolation of these data, it was estimated that by setting the threshold to 60000 pixels, the width change for the sucrose sample would be essentially zero. Consequently, in a fourth data evaluation step, the threshold was set at 60000 pixels, and the SPR dip width at 75% distance from the threshold to the dip minimum intensity was calculated. The width change was essentially zero for the sucrose sample and +0.43 angular units for the dye sample. Thus, the sensitivity with respect to the dye concentration was 0.0086 angular units per ppm. This example demonstrates the selection procedure of a physical measurand that is related to the absorbance but has a negligible dependence on the refractive index. The example also demonstrates how the value of this measurand can be correlated or calibrated with respect to the dye concentration.

### Example 2

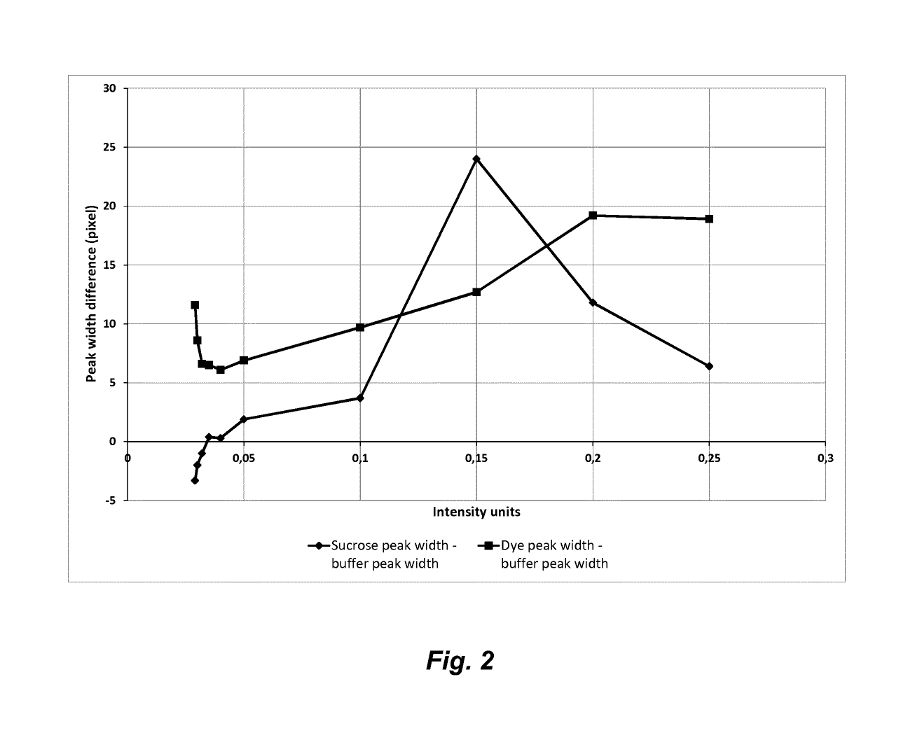

This example was performed on an SPR instrument with angular readout and full angular scans were continuously recorded at 670 nm. The SPR chip was a gold covered glass chip. Continuous flow of buffer was used for baseline readings. First, 1% of sucrose dissolved in running buffer was injected. Then, a 50 ppm solution of a dye with strong absorbance at 636 nm dissolved in running buffer was injected. Full SPR dips were recorded and saved for the buffer, the sucrose sample, and the dye sample. The full width of the SPR dips was measured at a number of fixed intensity values from 0.029 units (close to the dip minimum) to 0.25 units. The results are summarized in the table below and graphed in FIG. 2.

| | | | | Sucrose | |
|---|---|---|---|---|---|
| | | | | peak | Dye peak |
| | | | | width − | width − |
| | Buffer | Sucrose | | buffer | buffer |
| | peak | peak | Dye peak | peak | peak |
| Intensity | width | width | width | width | width |
| (normalized | (angular | (angular | (angular | (angular | (angular |
| units) | pixel) | pixel) | pixel) | pixel) | pixel) |
| 0.029 | 32.3 | 29 | 43.9 | −3.3 | 11.6 |
| 0.03 | 52.4 | 50.4 | 61 | −2 | 8.6 |
| 0.032 | 79.2 | 78.2 | 85.8 | −1 | 6.6 |
| 0.035 | 107.3 | 107.7 | 113.8 | 0.4 | 6.5 |
| 0.04 | 144.1 | 144.4 | 150.2 | 0.3 | 6.1 |
| 0.05 | 198.3 | 200.2 | 205.2 | 1.9 | 6.9 |
| 0.1 | 383.8 | 387.5 | 393.5 | 3.7 | 9.7 |
| 0.15 | 535.1 | 559.1 | 547.8 | 24 | 12.7 |
| 0.2 | 692.3 | 704.1 | 711.5 | 11.8 | 19.2 |
| 0.25 | 887 | 893.4 | 905.9 | 6.4 | 18.9 |

From the table it is obvious that the dip width is influenced not only by the absorbing dye sample but also by the non-absorbing sucrose sample. Also, the peak width difference between the sucrose and the buffer depends on the intensity value at which the dip width is read. In order to obtain a measurand that provides a good measure of the absorbance (or the dye concentration), the peak width should optimally be read at around 0.032-0.04 intensity units, where the influence of refractive index changes is least. For example, by performing the peak width measurement at 0.034 intensity units, the contribution from sucrose would be essentially zero, while the sensitivity with respect to the dye concentration would be approximately 0.13 angular pixels per ppm.

### Example 3

Competition assays are frequently used in SPR. This is a conceptual example that describes such an assay. An SPR sensing surface is coated with an antibody with affinity for the analyte, and the SPR phenomenon is monitored. In a first step, the selection of a suitable measurand that is related to the absorbance but has a negligible dependence on the refractive index is performed e.g. as is outlined in Example 1 or 2. In a second step, using the selected measurand, a calibration curve is run using mixtures with different but known concentrations of the analyte and of analyte or analyte analogue labelled with a suitable dye. In a third step, the unknown sample is mixed with a known concentration of the labelled analyte analogue, the SPR signal emanating from the dye is determined, and the concentration of analyte in the unknown sample is determined from the calibration curve.

### Example 4

Inhibition assays are frequently used in SPR. This is a conceptual example that describes such an assay. An SPR sensing surface is coated with the analyte or with an analyte analogue, and the SPR phenomenon is monitored. In a first step, the selection of a suitable measurand that is related to the absorbance but has a negligible dependence on the refractive index is performed e.g. as is outlined in Example 1 or 2. In a second step, using the selected measurand, a calibration curve is run using pre-equilibrated mixtures with different but known concentrations of an antibody, labelled with a suitable dye, with affinity for the analyte and of analyte. In a third step, the unknown sample is mixed with a known concentration of the labelled antibody and allowed to equilibrate. The SPR signal emanating from the dye is determined, and the concentration of analyte in the unknown sample is determined from the calibration curve.

### Example 5

Sandwich assays are frequently used in SPR. This is a conceptual example that describes such an assay. An SPR sensing surface is coated with an antibody with affinity for the analyte, and the SPR phenomenon is monitored. In a first step, the selection of a suitable measurand that is related to the absorbance but has a negligible dependence on the refractive index is performed e.g. as is outlined in Example 1 or 2. In a second step, using the selected measurand, a calibration curve is run using different but known concentrations of the analyte. After each analyte injection, a secondary antibody, labelled with a suitable dye, with affinity for the analyte is injected. In a third step, the sample containing an unknown concentration of analyte is injected, followed by injection of the labelled secondary antibody, and the concentration is determined from the calibration curve.

### Example 6

Determination of kinetic and equilibrium constants of molecular interactions are frequently done using SPR. This is a conceptual example of a competitive kinetic assay using the methods suggested by the present invention. An SPR sensing surface is coated with a receptor with affinity for a ligand, and the SPR phenomenon is monitored. In a first step, the selection of a suitable measurand that is related to the absorbance but has a negligible dependence on the refractive index is performed e.g. as is outlined in Example 1 or 2. In a second step, using the selected measurand, different but known concentrations of a ligand or ligand analogue labelled with a suitable dye is run, the SPR signal emanating from the dye is determined, and the kinetic constants kₒₙ and k_{off} and the equilibrium constant K_{D} are determined. The ligand analogue has an affinity for the same receptor as the ligand. In a third step, mixtures of the ligand to be studied and of labelled ligand analogue are run. Now the ligand and the ligand analogue compete for the same affinity sites on the surface. The specific signal emanating from the dye is monitored in real time, and the kinetic and equilibrium constants of the ligand-receptor interaction are calculated through the mathematical methods of competitive kinetics (R. Karlsson, Anal. Biochem. 1994, 221, 142; R. Karlsson, A. Fält, J. Immunol. Methods 1997, 200, 121).

By using the method outlined in this example, the kinetic and equilibrium constants of a number of different ligands with affinity for the same receptor may be determined through competition with and comparison with the same labelled ligand analogue, i.e. a reference compound. Also rapid affinity ranking of different ligands may be performed. The method may be especially useful within drug screening and fragment screening, where the interaction of a receptor with a large number of different ligands is usually studied.

### Example 7

Direct binding assays are frequently used in SPR. This is a conceptual example that describes such an assay. An SPR sensing surface is coated with a single strand DNA oligonucleotide, and the SPR phenomenon is monitored. In a first step, the selection of a suitable measurand that is related to the absorbance but has a negligible dependence on the refractive index is performed e.g. as is outlined in Example 1 or 2. In a second step, using the selected measurand, the surface is contacted with a sample containing a complementary DNA strand labelled with a suitable dye and, by analysing the SPR signal specific to the dye, the interaction of the DNA strands is studied. The interaction includes binding and rearrangement kinetics and determination of the concentration.

The invention is, of course, not restricted to the aspects, embodiments, and variants specifically described above, or to the specific examples, but many changes and modifications may be made without departing from the general inventive concept as defined in the following claims.

1. A method of determining the amount of an optical probe species binding to or releasing from a surface plasmon resonance (SPR) sensor surface, the method comprising the steps of:
a) determining, at one single wavelength or at more than one wavelength, a physical measurand (xᵢ) that is related to the absorptivity of said optical probe species,
b) correlating the value of the measurand to the amount of said optical probe species binding to or releasing from said surface, respectively,
wherein the physical measurand (xᵢ) of step a) is a physical measurand in which the contribution from the refractive index is substantially zero.

2. The method according to claim 1, wherein the physical measurand of step a) is selected performing the steps:
a1) determining a plurality of physical measurands xₙ that are related to the absorbtivity of said optical probe species, and
a2) selecting a measurand xᵢ of the plurality of measurands in which the contribution from the refractive index is substantially zero.

3. (canceled)

4. The method according to claim 2, wherein the plurality of measurands are related to the peak width (PW) in the SPR curve of the reflected light intensity as a function of incidence angle.

5. The method according to claim 4, wherein the peak width (PW) is defined as the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

6. The method according to claim 4, wherein step a1) comprises:
determining, for the physical measurands that are related to the peak width, the change in peak width (ΔPW) upon a change in optical properties of a sample,
and step a2) comprises
selecting at least one measurand of the plurality of measurands in which k₂ is minimized or the ratio k₁/k₂ is maximized in the equation
ΔPW=k₁*Δ∈+k₂*Δn,
in which Δ∈ is the change in absorptivity and Δn is the change in refractive index upon a change in optical properties of the sample.

7. The method according to claim 1, wherein step b) comprises using the values of said measurand to discriminate between measurement noise (N) and the signal from the binding or release of said optical probe species.

8. The method according to claim 1, wherein step b) comprises determining at least one function f of the measurand f(x₁) such that the signal-to-noise ratio (S/N) of the optical probe species binding to or releasing from said SPR sensor surface increases.

9. The method according to claim 7, wherein the measurement noise (N) is due to at least one additional chemical species binding to or releasing from said SPR sensor surface, and that step b) comprises using the values of the measurand to discriminate between binding or releasing of said optical probe species and said at least one additional chemical species.

10. The method according to claim 7, wherein the measurement noise (N) has been determined by means of varying the binding or release of an additional chemical species to or from, respectively, said SPR sensor surface.

11. The method according to claim 7, wherein the measurement noise (N) is due to temperature variations, and that step b) comprises using the values of said measurand to discriminate between binding or releasing of said optical probe species and temperature variation noise.

12. The method according to claim 11, wherein the measurement noise (N) has been determined by means of varying the temperature of the medium in contact with said SPR sensor surface.

13. The method according to claim 7, wherein the measurement noise is due to variations of the composition of the medium in contact with the SPR sensor surface, and that step b) comprises using the values of said measurands to discriminate between binding or releasing of said optical probe species and said variations of the composition.

14. The method according to claim 13, wherein the measurement noise (N) has been determined by means of varying the composition of the medium in contact with said SPR sensor surface.

15. The method according to claim 1, wherein the sensing principle of the SPR sensor is based on internal reflection.

16. The method according to claim 15, wherein the sensing principle of the SPR sensor is based on optical waveguiding refractometry, frustrated total internal reflection, waveguide-based surface plasmon resonance, grating coupler refractometry, interference refractometry, or dual polarization interferometry.

17. The method according to claim 15, wherein the sensing principle of the SPR sensor is based on surface plasmon resonance (SPR) with angular readout.

18. The method according to claim 1, wherein at least one measurement wavelength is selected within 50 nm from the wavelength of maximum absorptivity of said optical probe species.

19. A method for estimating the absorbance ∈ of a sample in an optical sensor based on surface plasmon resonance (SPR), comprising the steps of:
a) determining a plurality of physical measurands (xₙ) that are related to the absorbance ∈ of said sample;
b) selecting a physical measurand xᵢ from the plurality of physical measurands (xₙ) step a) in which the contribution from the refractive index is substantially zero, and
c) using the physical measurand xᵢ from step b) for estimating the absorbance ∈.

20. The method according to claim 19, wherein the plurality of measurands xₙ are different measurands related to the peak width (PWᵢ) in the SPR curve of the reflected light intensity as a function of incidence angle.

21. The method according to claim 20, wherein the peak width (PW) is defined as the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

22. The method according to claim 20, wherein
step b) comprises determining the change in the peak widths (ΔPWₙ) for the plurality of measurands xₙ upon a change in optical properties of a sample medium run in the SPR sensor, and
step c) comprises selecting a ΔPWᵢ from the ΔPWₙ in which k₂ is minimized or the ratio k₁/k₂ is maximized in the equation ΔPW=k₁*Δ∈+k₂*Δn, in which Δ∈ is the change in absorptivity and Δn is the change in refractive index upon a change in optical properties of the sample, and using ΔPWᵢ for estimating the absorbance ∈

23. A calibration method for an optical sensor based on surface plasmon resonance (SPR), comprising the steps of:
a) running at least two calibration samples having different refractive index n and at least two calibration samples having different absorbance ∈,
b) determining at least one peak width PWₙ in the SPR curve of the reflected light intensity as a function of incidence angle for each sample,
c) estimating the change (ΔPWₙ) for the at least one peak widths PWₙ between said calibration samples,
d) selecting a ΔPWᵢ of the ΔPWₙ of step c) in which k₂ is minimized or the ratio k₁/k₂ is maximized in the relation ΔPW=k₁*Δ∈+k₂*Δn, in which Δ∈ is the change in absorptivity and Δn is the change in refractive index upon a change in optical properties of the sample

24. The method according to claim 23, further comprising the step
d) using the PWᵢ for analysing the amount of an optical probe species in said samples binding to or releasing from the optical sensor surface

25. The method according to claim 23, wherein at least one peak width of step b) is defined as the peak width at a predetermined value of the absolute intensity, the peak width at a predetermined value of the relative intensity (expressed e.g. as a percentage between the maximum and the minimum intensity), the peak width at a predetermined intensity value above the minimum intensity and/or the standard deviation or the moment of inertia of the SPR dip determined relative to a baseline defined at an absolute or relative intensity value.

26.-29. (canceled)

30. A computer program product comprising computer-executable components for causing a device to perform any one or all of the steps recited in claim 1 when the computer-executable components are run on a processing unit included in the device.

31. A reagent kit comprising at least one optical probe species and instructions on how to use it in a method according to claim 1.

32. The reagent kit according to claim 31, comprising a first sample with a measurable refractive index (RI) and with a negligible absorbance, a second sample with a refractive index (RI) different from that of the first sample and with a negligible absorbance, and a third sample with a measurable absorbance.

33. A reagent kit comprising the computer program product of claim 30.
